(19) United States
(12) Patent Application Publication
(10) Pub. No.: US 2008/0143211 A1
(43) Pub. Date: Jun. 19, 2008

(54) Face Commutator and Method for Producing a Face Commutator

(76) Inventor: Ernst-Rudolf Hein, Nalbach (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/886,162

(22) PCT Filed: Jun. 12, 2006
(86) PCT No.: PCT/EP2006/005594

§ 371 Date: Sep. 12, 2007

(30) Foreign Application Priority Data
Jun. 16, 2005 (DE) 10 2005 028 791.3

(51) Int. Cl. H01R 39/06; H01R 43/06

(52) U.S. Cl. 310/234; 310/233; 29/597

(57) ABSTRACT

The invention relates to a face commutator (101) having a supporting body (102) consisting of an electrically insulating material, a large number of connection segments (108) consisting of an electrically conductive material for connecting in each case at least one end of a coil winding, and a large number of contact surface segments (112) which form a contact surface (14) of the face commutator (101), the contact surface segments (112) being mechanically rigidly and electrically conductively connected to the connection segments (108), and the supporting body (102) and/or the connection segments (108) having an integral design, and the supporting body (102) being prefabricated and having openings (118) into which the connection segments (108) are inserted, characterized in that the supporting body (102), at least in sections, is overdimensioned in the region of the openings (118) in relation to the inserted connection segments (108), in that the connection segments (108) are fixed owing to a clamping effect of the supporting body (102), and in that the clamping effect is brought about by the overdimensioning at least in sections, of the supporting body (102) in relation to the connection segment (108), as well as to a method for producing a face commutator.

The invention relates to a face commutator, especially a carbon, plug-in face commutator, and a method for producing such a face commutator.

Face commutators, such as these, are used for example for fuel pumps. The electrically conductive connection segments, which usually consist of copper or which contain copper in this medium, do not have the resistance necessary for continuous operation. For this reason the contact surface segments which have higher resistance compared to the medium surrounding the face commutator are used for the contact surface of the face commutator.

Face commutators, such as these, are known for example from WO 97/03486 A1. In this connection, a supporting body of electrically insulating material which forms the hub for the commutator is molded onto a conductor blank which forms one of the connection segments. For this purpose the conductor blank is inserted into a corresponding mold and molded in the mold with a mass which forms the supporting body. Then a carbon ring disk which forms the contact surface segments is soldered onto the conductor blank and then separated into contact surface segments. Face commutators which have been produced in this way meet high quality requirements, but the production process is accordingly complex and thus expensive.

DE 199 26 900 A1 discloses a process for producing a face commutator in which the surfaces of the metal segment support parts exposed by the division of the supporting body, are coated with a layer which is resistant to the environment, for example against fuels.

EP 1 363 365 A1 discloses a commutator according to the preamble of claim 1. The connection segments have a connection section for connecting one end of a coil winding and a contact section for electrical connection to the contact surface segment. After inserting the connection segments into the supporting body the connection sections are bent at a right angle and parallel to the plane of the contact surface. Then a carbon-containing disk which is divided by parting cuts is applied to the bent connection sections and thus forms the contact surface segments. The carbon-containing disk is composed of two layers which are connected to one another by cold pressing. The first layer assigned to the connection segments contains a binder. When applied to the connection segments under the action of heat the binder softens and the first layer flows with the simultaneous action of pressure into openings of the connection segments and of the supporting body and thus anchors the carbon-containing disk on the supporting body.

Therefore the object of the invention is to make available a face commutator and the pertinent production process which overcome the disadvantages of the prior art, are especially more economical and still ensure sufficient resistance of the commutators produced in a reaction-promoting environment.

The object is achieved by the face commutator defined in claim 1 and by the production process defined in the independent claim. Special embodiments of the invention are defined in the dependent claims.

For face commutators, in contrast to so-called barrel commutators, the contact surface for the commutator brushes is formed by a plane end surface. Accordingly the structure of face commutators is different from to the structure of barrel commutators.

The face commutator according to the invention has a supporting body of electrically insulating material, for example of a duroplastic. On the supporting body there are a plurality of connection segments which are designed for connection of at least one end of a coil winding at a time, for example of the rotor of an electric motor, and which consist of a material with good electrical conductivity, for example of copper or a copper alloy. To increase the resistance of the contact surface of the commutator to the medium surrounding the commutator, the face commutator moreover has a plurality of contact surface segments which jointly form the plane contact surface of the face commutator, the number of contact surface segments generally corresponding to the number of connection segments, especially is identical to it or is an integral fraction or integral multiple of it.

According to the invention, the supporting body has openings into which the connection segments are inserted. One particularity consists in that the supporting body as a separate part is produced before insertion of the connection segments with its mold which has openings for accommodating the connection segments. In this way the supporting body can be produced in a simplified manner with high dimensional accuracy, for example also by an injection molding process. In particular the peripheral injection of the connection segments which is very complex in terms of production engineering is eliminated in the formation of the supporting body.

The supporting body is preferably made in one piece and specifically integrally forms the openings for insertion of the connection segments, the contact surfaces for the prefabricated contact surface segments, and contact surfaces for those sections of the connection segments to which the coil winding is connected. The connection segments are preferably made in one piece, especially the connection segments form both the contact surfaces facing the contact surface segments and also the connecting surfaces for the coil winding in one piece.

Because the connection segments can be inserted into the supporting body, numerous advantages are ensured. Thus the requirement of producing a conductor blank which forms the connection segments is eliminated. Moreover this conductor blank need no longer be supplied to an injection molding machine for injecting the supporting body on.

Furthermore it is advantageous that the connection segments are no longer surrounded over the entire surface by the press material which forms the supporting body so that the different coefficients of thermal expansion of the material of the connection segments and of the material of the supporting body no longer cause thermally induced stresses.

The contact surface segments are connected mechanically tightly and by electrical conductivity to the connection segments. This connection can take place for example by a soft solder, a hard solder, or also a cement. The contact surface segments can be fixed individually on the respective connection segments or fixed in a combination for example in the form of a disk or ring disk on the connection segments and then can be separated by parting cuts. The connection segments are also mechanically fixed on the face commutator by the mechanically tight connection to the contact surface segments.

The connection segments can also be fixed solely as a result of a clamping action of the supporting body, and this clamping action can be caused by an at least sectional overdimension of the supporting body with reference to the connection segment. If necessary, the fixing of the connection segments on the supporting body can be improved by an additional connecting means, for example by a cement. In any case, by connecting the contact surface segments to the connection segments the fixing of the segments on the supporting body is at any rate further improved in the direction of stress during operation of the face commutator.

The contact surface segments relative to the connection segments, especially relative to the end of the connection segments which faces the contact surface segments, have a projection which extends obliquely or transversely to the insertion direction, by means of which the combination of the contact surface segment and connection segment is anchored on the supporting body. In this way the combination is secured especially against shifting in the insertion direction.

The projection can be formed at least partially also by a connecting means which connects the contact surface segment to the connection segment, for example by a solder. Preferably the contact surface segments in the region on the projection at least in sections abut the supporting body so that the supporting body itself forms an abutment for axial fixing of the connection segments.

The openings in the supporting body for holding the connection segments run at least partially parallel to the axis of the supporting body, preferably the openings extend parallel to one longitudinal axis of the supporting body which preferably coincides with the axis of rotation of the face commutator. The openings in the supporting body are open at least in sections toward the peripheral surface of the face commutator, especially in the section in which the connection segment forms a preferably radially projecting connecting means for connection of the coil winding. In one alternative embodiment the openings for holding the connection segments run in the radial or tangential direction with reference to the supporting body.

In the region of the end of the connection segments facing the contact surface segments the openings in the supporting body have a widening. This widening preferably forms a receiving space for a connecting means, for example a solder or cement, for connecting the connection segments to the contact surface segments. After setting, the connection means preferably even by itself, especially in conjunction with the pertinent contact surface segment, forms anchoring of the connection segment on the supporting body.

This applies especially when the connection means in the region of the transition from the connection segment to the pertinent contact surface segment as a result of the acting surface tension widens in the manner of a funnel, as is the case for example for solder and cement connections. In this way moreover the entry of the medium surrounding the face commutator into the region of the connection segments is reliably prevented and thus the connection segments are protected against corrosion.

In this connection it is especially advantageous if the connection segments in the inserted state with their end facing the contact surface segments project into the region of the widening. In this case the connecting means can act not only axially on the connection segment, but can also at least partially surround it in the peripheral direction, by which the joint action is improved. In this way the connecting means itself can form a type of tie rod and can secure the connection segment against axial displacement.

The connection segments have a head section and a base section which are connected to one another via a connection section. The pertinent opening in the supporting body at least in sections has an overdimension, for example such that the part of the supporting body which lies between the head section and the base section is compressively stressed, and/or depending on the dimensioning of the connection segments—the connection section of the connection segment is tensioned. It is especially advantageous here if the surfaces of the head section and base section which are generally opposite one another and which adjoin the supporting body include an angle of less than 90°, because then the stresses which occur in the supporting body as a result of the clamping of the connection segment are largely balanced, especially these stresses run essentially in the radial direction with reference to the longitudinal axis of the face commutator, and thus the face commutator even in continuous operation under high stress has a stable supporting body.

The connection segments are made as identical parts, especially as punched or hammered parts, or in the simplest case they are produced by cutting a corresponding section to length. With respect to matching of the geometrical dimensions of the connection segment with reference to the pertinent opening in the supporting body, it is especially advantageous that precision matching of these dimensions of the connection segment can be done with little effort by adjusting the punching tool. In this way the requirements for dimensional accuracy of the supporting body are reduced; this greatly simplifies its production process.

The connection segments can have a coating at least in the region of the connection to the contact surface segments. The material of the coating is preferably matched to the material of the connecting means, for example the connection segments in the case of a solder connection at least in the region of the connection to the contact surface segments, generally over the entire surface, are coated with tin or a material corresponding to the solder layer.

The contact surface segments consist of a material which compared to the medium surrounding the face commutator has a higher resistance than the connection segments. Preferably the material of the contact surface segments contains carbon, and both a so-called soft fired carbon and a hard fired carbon can be used. Preferably the contact surface segments, however, on their sections facing the connection segments have a coating, by which the connection is further improved.

The invention also relates to a process for producing a face commutator in which the supporting body is separately produced from an electrically insulating material, in the same manner as the connection segments which are inserted into the openings of the supporting body. Then the contact surface segments which form the contact surface of the face commutator are fixed. The contact surface segments can be present separated and can each be fixed individually on the pertinent connection segment, or in combination, for example in the form of a ring disk, can be fixed on the connection segments and then separated by parting cuts.

Other advantages, features and details of the invention will become apparent from the dependent claims and the following description in which several embodiments are described in detail with reference to the drawings. The features mentioned in the claims and specifications can each be essential for the invention individually for themselves or in any combination.

FIG. 1 shows a cross section through a face commutator known from the prior art,

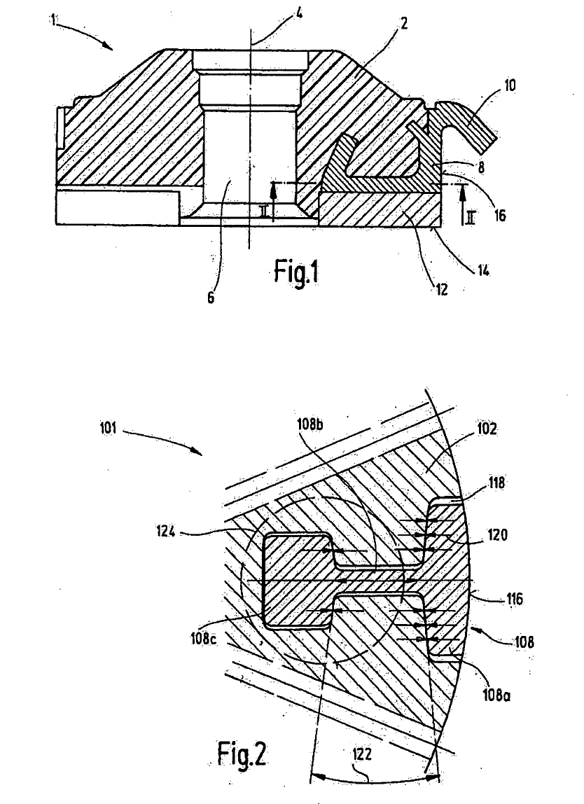

FIG. 2 shows a front view of a cross section through a face commutator according to the invention,

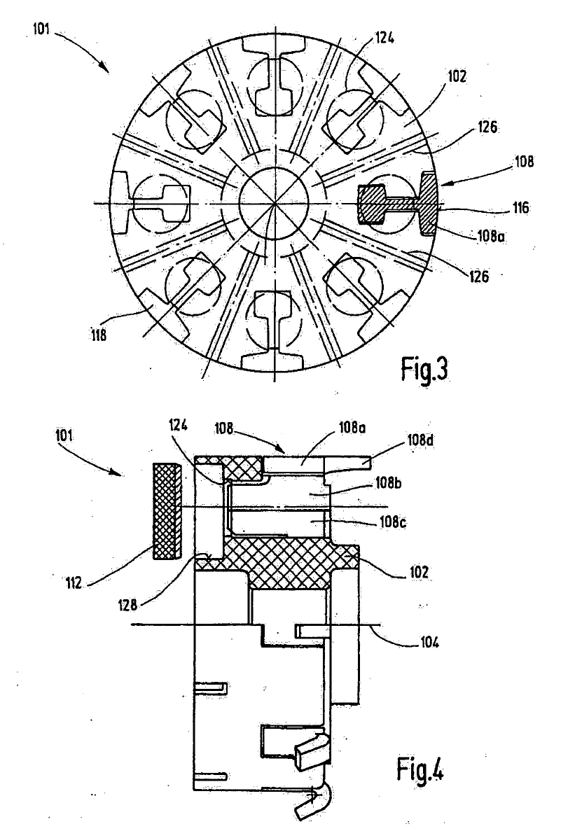

FIG. 3 shows a top view of the face commutator,

FIG. 4 shows a side view of the face commutator as claimed in the invention,

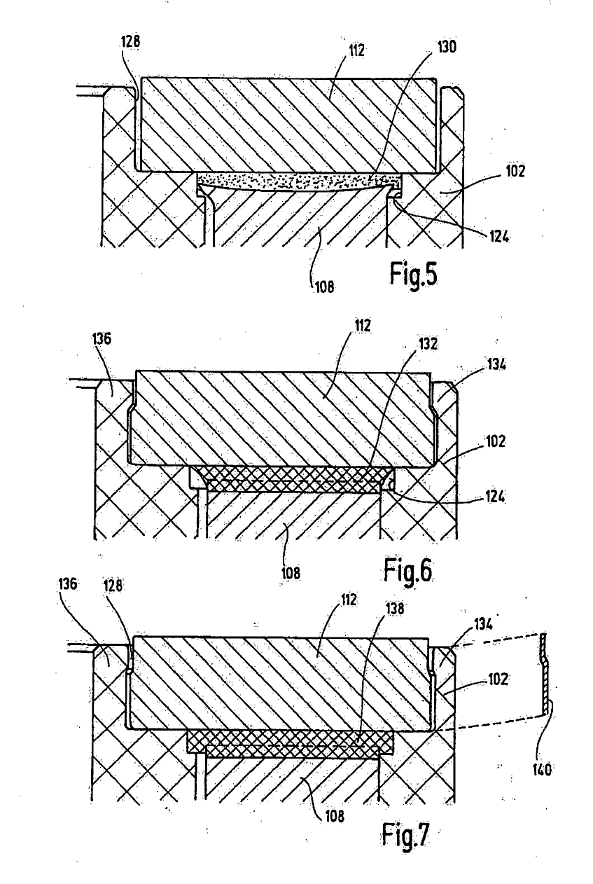

FIG. 5 shows a section through a first embodiment of the connection between the connection segment and contact surface segment,

FIG. 6 shows a section through a second embodiment of the connection between the connection segment and contact surface segment,

FIG. 7 shows a section through a third embodiment of the connection between the connection segment and contact surface segment,

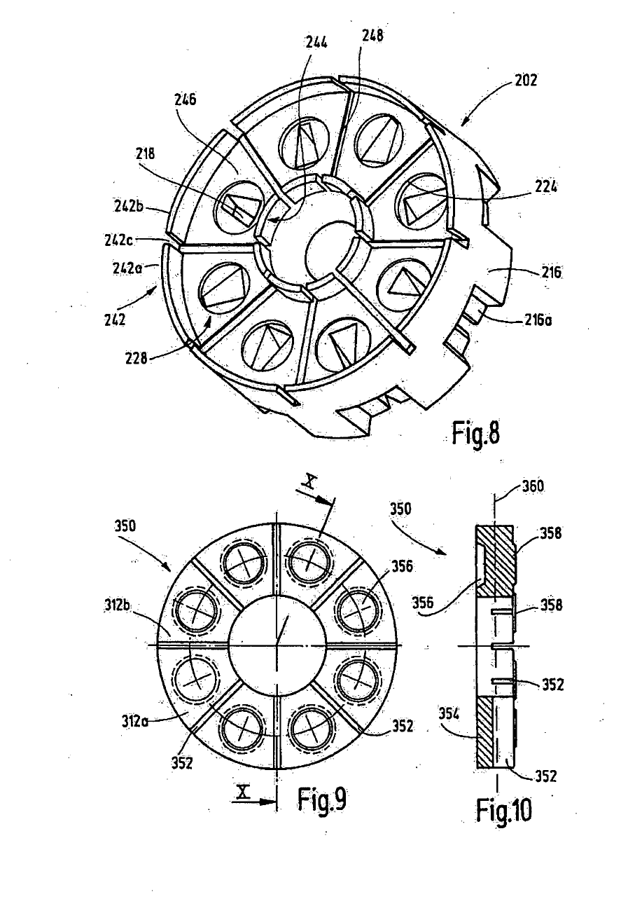

FIG. 8 shows a perspective view of a second embodiment of the supporting body,

FIG. 9 shows a top view of a special embodiment of the contact surface segments,

FIG. 10 shows a section along X-X in FIG. 9,

FIG. 11 shows a second embodiment of the face commutator in a side view,

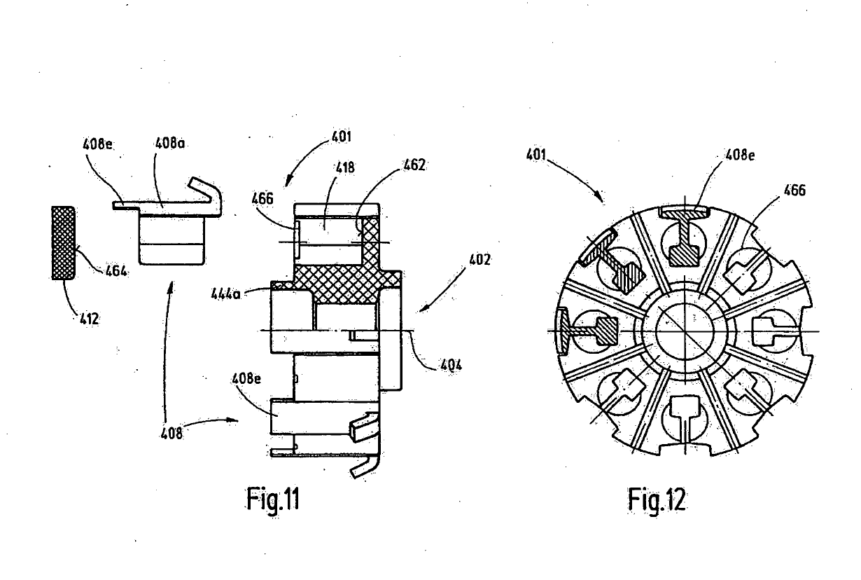

FIG. 12 shows a top view of the face commutator of FIG. 11,

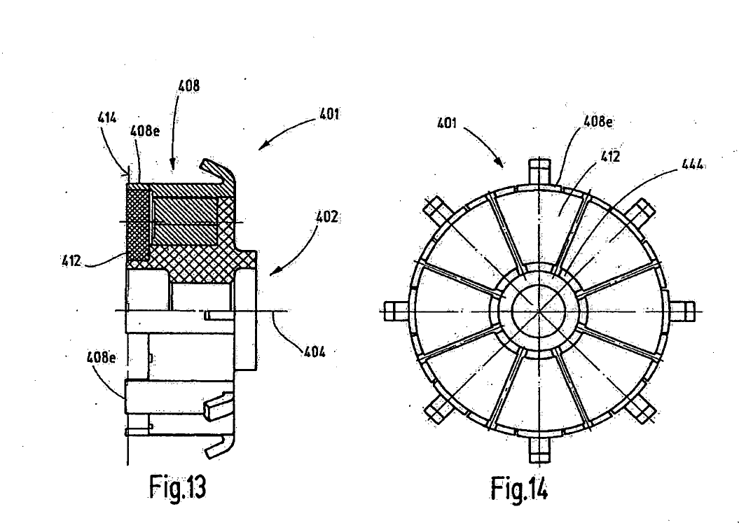

FIG. 13 shows the face commutator of FIG. 11 in the assembled state in a side view,

FIG. 14 shows a top view of the face commutator of FIG. 13, and

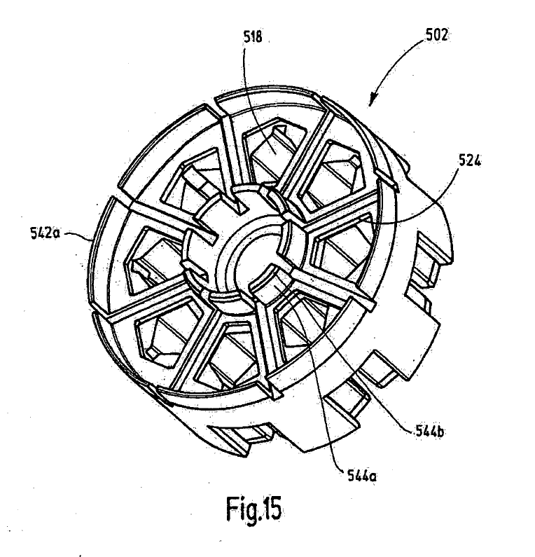

FIG. 15 shows another embodiment of the supporting body 502.

FIG. 1 shows a cross section through a face commutator known from the prior art. The face commutator 1 has a supporting body 2 of electrically conductive material. The supporting body 2 has a longitudinal axis 4 which also coincides with the axis of rotation of the face commutator 1. In particular the face commutator 1 can be axially symmetrical to the longitudinal axis 4. In the region of the longitudinal axis 4 the face commutator 1, especially the supporting body 2, forms an opening 6 for passage of the axle of an electric motor.

The supporting body 2 is molded onto the connection segments 8 which radially on the outside have a bent hook 10 for connection of at least one end of the respective coil winding. The contact surface 14 of the face commutator 1 is formed by contact surface segments 12 which are connected mechanically tightly and electrically conductively to the connection segments 8. The entirety of the contact surface segments 12 which are located preferably uniformly distributed in a circle around the longitudinal axis 4 forms the plane contact surface 14 of the face commutator 1. Radially outside, the connection segments 8 form a peripheral surface 16, from which the hooks 10 are bent off. Other details of the face commutator 1 can be taken from WO 97/03486 A1.

FIG. 2 shows a view of a cross section through a face commutator according to the invention, which view arises in a section corresponding to II-II in FIG. 1. The connection segments 108 have a head section 108a and a base section 108c which are connected to one another via a connecting section 108b. FIG. 2 shows the region of a contact surface segment (not shown) which in its contour is roughly congruent with the cut surface of the supporting body 102. The supporting body 102 has a plurality of openings 118 which are arranged distributed regularly on the circumference and into which the connection segments 108 can be inserted. Insertion is done preferably in the direction parallel to the longitudinal axis of the face commutator 101 which runs perpendicular to the plane of FIG. 2.

In the region of the head section 108a the opening 118 has an overdimension in the peripheral direction. This reliably prevents a pertinent underdimension of the opening 118 due to tolerances in production; this underdimension would deliver compressive stresses running in the peripheral direction into the supporting body 101 which can lead to problems with respect to the permanent stability of shape of the supporting body 102. The corresponding applies to the opening 118 in the region of the base section 108c; here the opening 118 especially in the peripheral direction has an overdimension relative to the dimensions of the base part 108c.

Also relating to its radial extension in the section between the contact surface for the region of the head section 108a, which region is pointed radially to the inside, and the contact surface for the region of the base section 108c which is pointed radially to the outside, the opening 118 with respect to the radial extension of the connecting section 108b has an overdimension so that in these regions the connection segment 108 is in contact with the contact surfaces formed by the opening 118 and especially on these surfaces the forces indicated in FIG. 2 by the arrows 120 are applied.

This overdimension of the opening 118 causes compressive stresses to be applied to the supporting body 102 in the region of the connecting section 108b. The cause of these compressive stresses is the tensile stresses in the connection section 108b, with an extension in the peripheral direction which is smaller than the corresponding extension of the head section 108a and of the base section 108c. Accordingly the connection section 108b stretches elastically in the radial direction. The connection segment 108 acts as an energy storage mechanism. Stretching takes place preferably within the elastic limit of the connection segment 108, for example by an amount between 5 and 50 μm. Otherwise the opening 118 in the region of the connecting section 108b in the peripheral direction has an overdimension so that no compressive forces in the peripheral direction are applied to the molded body 102 at this location.

The angle 122 enclosed by the facing end sides of the radially outer region of the base section 108c and the radially inner region of the head section 108a is less than 90°, preferably between 30° and 60°, especially approximately 50°, and in this embodiment between 4° and 30°, especially approximately 15°. This acute angle ensures that the compressive stresses applied to the supporting body 102 as a result of the stretching of the connection section 108b from the connection segment 108 essentially mutually balance one another, especially a negligibly small resulting pressure component in the peripheral direction remains.

In the face commutator 101 according to the invention, the connection segments 108 and the supporting body 102 accordingly are joined essentially in a stress-neutral manner. The forces which occur upon insertion and which lead to effective clamping and thus fixing of the connection segments 108 in the supporting body 102 are advantageously mutually cancelled. In particular no resulting forces remain which act in the peripheral direction and/or act radially to the outside so that the face commutator 101 even under difficult conditions of use, such as for example elevated temperature, reliably retains its stability of shape.

This is also achieved preferably in that one section of the connection segments 108 at a time is tensioned and is used as an spring-elastically deformable element. The connection segments 108 are inserted preferably in the axial direction into the supporting body 102, insertion being possible fundamentally from both end sides of the supporting body 102. But in many cases insertion from the side of the supporting body 102 facing away from the contact surface segments 112 is preferred. Profiling of the connection segments 108 enables automatic centering of the connection segments 108 in the supporting body 102 so that supply and insertion of the connection segments 108 can be automated very easily.

Moreover, it is possible when the connection segments 108 are inserted against a stop, to insert especially a pressure pad which can be positioned relative to the supporting body 102. In this connection it is advantageous for anchoring of the connection segments 108 on the supporting body 102 if the stop is made for example in the form of a mandrel and makes contact in the central region of the base section 108c and causes spreading of the base section 108 there by the insertion force or pressure force upon insertion.

In the region which is associated with the contour 124 which is shown by the broken line in FIG. 2, the supporting body 102 near the end of the connection segments 108 which faces the contact surface segments 112 has a widening which can be used to accommodate the connection means for connection between the connection segment 108 and contact surface segment 112.

FIG. 3 shows a top view of the face commutator 101, especially of the supporting body 102, to the extent in agreement with FIG. 2, the connection segment 108 being inserted only into the opening 118 in the three o'clock position. The other, altogether eight openings 118 in the illustrated state of the face commutator 101 are not yet equipped with connection segments 108. The contact surface segments 112 are likewise not yet in place, but their contour is indicated by the broken lines 126. The head regions 108a run with their radially outer contour according to the outer contour of the supporting body 102 and thus in sections form a relatively flush peripheral surface 116 of the face commutator 101.

FIG. 4 shows a side view of a face commutator 101 according to the invention and in the bottom half of the figure in a front view and in the top figure half partially in a cross section. The connection segment 108 shown in a front view in the top half of the figure is inserted into the supporting body 102 and clamped. In the illustrated state the head section 108a integrally forms a plug-in or plate connection 108d for connecting at least one coil winding. Instead of the illustrated plug-in or plate connection 108d the head section 108a in this region can also be bent in a hook shape (compare FIG. 1) or can have an insulation piercing connection which penetrates the insulation of the coil connection winding, or also a solder connection for soldering on the coil winding. Both for possible bending and also attachment of the coil connection winding is it advantageous for the connection segment 108 in the illustrated inserted state to be connected relatively tightly to the supporting body 102.

In the region of the end of the connection segment 108 facing the contact surface segment 112 the opening 118 in the supporting body 102 has a first widening 124 and a second widening 128. The second widening 128 is used for optionally also positive holding of the contact surface segments 112 and when the contact surface segments 112 are present in combination, can for example be present in the form of a ring disk, also in an annular second widening 128.

Conversely, the first widening 124 is preferably provided individually to the respective connection segment 108, and can be made for example in a circular shape. The space radially bordered by the first widening 124 can form a receiving space for a connecting means for connecting the connection segment 108 to the contact surface segment 112. In this regard it is especially advantageous if the connection segment 108 projects into the region of the first widening 124 in the axial direction, i.e. in the direction parallel to the longitudinal axis 104, with its end facing the contact surface segment 112. In this case the connecting means can adjoin the axial end side of the connection segment 108 not only superficially, but can also overlap it in the manner of a cap and moreover can effect an additional seal between the connection segment 108 and the supporting body 102. Preferably the connection segment 108 at least on its end facing the contact surface segment has a coating which improves the mechanical connection and/or electrical contact-making.

Due to the radial projection of the contact surface segment 112 relative to the connection segment 108 this arrangement after connection forms a reliable attachment to the supporting body 102 in the manner of anchoring, especially relative to axially acting forces. This attachment is further improved by the contact surface segment 112 at least in sections being in preferably planar contact with the supporting body 102.

The contact surface segments can have several layers, especially can be a multilayer disk before segmenting. The multilayer disk can have a carbon layer or carbon-containing layer which forms the contact surface, and another layer which faces the connection segments and which has at least one metallic component, for example copper, tin, brass or alloys. The other layer is used especially to improve the electrical and/or mechanical connection to the connection segments. The multilayer disk can be produced by a sintering process. Alternatively, after the shaping process the disk can also be coated.

FIG. 5 shows a section through a first embodiment of the connection between the connection segment 108 and the contact surface segment 112. The particularity of this first embodiment is among other things that the connection segment 108 when inserted into the supporting body 102 would be pressed against a stop, an abutment, a mandrel or the like such that a projection which extends into the first widening 124, especially a radial projection, is formed which provides for secure axial anchoring of the connection segment 108 in the supporting body 102, especially by engagement of the connection segment with the undercut formed by the first widening 124.

This anchoring is further strengthened by the mechanically tight and electrically conductive connection of the connection segment 108 to the contact surface segment 112, this connection in the illustrated first embodiment taking place by means of an electrically conductive cement layer 130. The cement layer 130 adjoins not only the end surface of the connection segment 108 and the corresponding end surface of the contact surface segment 112, but also fills the region of the first widening 124 in the radial direction, so that sealing and especially complete coverage of the connection segment 108 are ensured by the cement layer 130. It is also possible to cement the connection segments 108 themselves to the supporting body 102.

FIG. 6 shows a second embodiment of the connection between the connection segment 108 and the contact surface segment 112. A first difference from the first embodiment consists in the type of connection layer, this second embodiment being a solder layer 132 which as a result of the acting surface tension has a funnel-shaped widening in the direction to the contact surface segment 112 and in this way and especially without the connection segment 108 having to be spread, provides for radial engagement with the region of the first widening 124 and thus for formation of a tie rod with respect to the axial mobility of the connection segment 108.

Another particularity of the second embodiment consists in the type of shaping of the front-side end of the supporting body 102. It tapers the second widening 128 on the end side, for example by means of the first projection 134 which is pointed radially inside and which is located radially outside, and/or by means of the second projection 136 which is pointed radially outside and which is located radially inside. The pertinent contact surface segments 112 are accordingly made step-shaped and with their end facing the connection segments 108 extend behind the first and/or second projection 134, 136 of the second widening 128. The corresponding shape of the contact surface segments 112 can be made available either in the shaping process or, for example in the case of attaching the contact surface segments 112 in combination in the form of a ring disk, by turning such a ring disk.

By the matched shaping of the supporting body 102 and the contact surface segments 112, it is possible to clip the contact surface segments 112 into the second widening 128, i.e. to fix them on the supporting body 102 by spring locking. For a corresponding, especially axial projection of the connection segment 108 into the region of the second widening 128, and/or for a corresponding, especially axial projection of the contact surface segments 112 into the region of the first widening 124, it is also possible for a mechanically relatively strong and electrically relatively conductive connection between the contact surface segments 112 and the connection segments 108 to be made available solely by the locking of the contact surface segments 112 on the supporting body 102. The locking of the contact surface segments 112 on the supporting body 102 in any case yields the advantage of pre-fixing which in subsequent cementing or soldering provides for the contact surface segment 112 to be and remain in the correct position with respect to the pertinent connection segment 108. Moreover the contact surface segment 112 can also be held in especially flat contact with the supporting body by locking.

In addition to the solder layer 132 shown in FIG. 6, an additional sealing means can be inserted into the annular gap which is formed between the contact surface segments 112 and the supporting body 102, for example also an adhesive layer, in order to prevent entry of corrosive media into these regions.

FIG. 7 shows a third embodiment of the connection between the connection segments 108 and the contact surface segments 112. A first difference from the other two embodiments is that the connection layer 138 between the connection segments 108 and the contact surface segments 112 essentially completely fills the space of the first widening 124 and in this way also forms an absolutely reliable seal of the supporting body 102 relative to the connection segments 108.

Another particularity consists in that the supporting body 102 on its axial end in the region of the second widening 128 does in turn provide a taper with the formation of annular or partially annular, optionally also only spot projections 134, 136 which with respect to their dimensions can even be identical to those of the second embodiment of FIG. 6, that however the dimensions of the contact surface segment 112 are less that the inside width of the second widening 128 which is determined by the two projections 134, 136. In this way, when the contact surface segment 112 is inserted into the second widening 128 the contact surface segment 112 is not clipped in, but can be loosely inserted.

If at this point the resulting annular gap between the contact surface segment 112 and the supporting body 102 is filled for example with a hardenable mass, especially a cement, in this way a preferably annular locking body 140 is formed which fills the annular gap and which ensures positive fixing of the contact surface segments 112 on the supporting body 102 as a result of its shape and as a result of the interaction with the contour of the supporting body 102, in the embodiment of FIG. 7 with the first and/or second projection 134, 136, and with the contour of the contact surface segment 112.

In all three embodiments relating to the connection between the connection segment 108 and the contact surface segment 112, the connecting layers 130, 132, 138 form a rim, funnel or some other type of anchor element which extends into the first widening and by which the connection segment 108 and thus also the contact surface segment 112 are permanently and reliably fixed in the axial direction on the supporting body 102.

FIG. 8 shows a perspective view of a second embodiment of a supporting body 202. The first difference from the supporting body 102 of the first embodiment consists in the essentially trapezoidal cross sectional contour of the opening 218 for the connection segments. Besides this, the first widening 224 is circular in a top view and in the illustrated second embodiment covers the entire opening 218. The first widening 224 in turn forms a deposition space for a connection means. Altogether the supporting body 202 has eight openings 218 for the connection segments.

The second widening 228 is bordered radially to the outside by an outer ring 242 which is formed integrally by the supporting body 202 and radially inside by an inner ring 244 which is formed in one piece by the supporting body 202. Both the outer ring 242 and also the inner ring 244 are formed by ring segments 242a, 242b which are assigned to the respective contact surface segments. Between adjacent ring segments 242a, 242b there is a respective recess 242c with an extension in the peripheral direction which is larger than the width of the tool for segmenting of the contact surface segments. In this way it is possible to separate the contact surface segments which are fixed in a combination, for example as a ring disk, on the supporting body 202 or the pertinent connection segments by parting cuts, without in doing so having to cut the outer and/or inner ring bridge 242, 244. In this way the service life of the cutting tool is greatly increased. Moreover a higher cutting speed can be achieved because breaking out of the outer ring 242 and/or of the inner ring 244 need no longer be prevented by a reduction of the cutting speed.

Another particularity of the supporting body 202 consists in that in the contact surface 246 of the supporting body 202 there are recesses for the segmenting of the ring disk, especially radially running grooves 248 which are flush with the corresponding recesses 242c in the outer ring 242 and inner ring 244. The depth of these grooves 248 is chosen such that reliable separation of the ring disk is ensured without sawing into the supporting body. If these grooves 248 are still filled with a preferably electrically nonconductive cement, not only is the additional connection of the contact surface segments with the supporting body 202 ensured, but also the generally carbon-containing contact surface segments are reliably prevented from breaking out when being cut apart.

In particular by using a supporting body 202 with an outer ring 242, a so-called soft-fired carbon can also be used for the contact surface segments, i.e. a plastic-bonded carbon with an exact composition which can be selected matching with the pertinent commutator brushes. In the region of the peripheral surface 216 the supporting body 202 has recesses 216a which are used to hold the connection segments, especially for that section of the connection segments which is intended for connecting the coil windings.

In the production of the face commutator according to the invention it is especially also possible, after inserting the connection segments 108 into the supporting body 102, in the region of the first widening 124 or over the entire surface into the region of the contact surface 246 to insert a preferably anaerobically setting and electrically conductive cement or some other electrically conductive connecting means, and especially the first widening 124 can be used as a kind of deposition space for such a connection means. To improve the connection between the connection segment 108 and the contact surface segment 112 the contact surface segment 112 can be accordingly coated, for example tin-plated, at least on the surface facing the connection segment 108, optionally also over the entire surface.

FIG. 9 shows a top view of one special embodiment of the contact surface segments, specifically in the form of a presegmented contact surface disk 350. FIG. 10 shows a section along X-X in FIG. 9.

This contact surface disk 350 can be segmented by radial parting cuts into individual contact surface segments 312a, 312b. In this case this segmenting is achieved by the radial grooves 352 which have already been molded in when the contact surface disk 350 is shaped, in conjunction with reduction of the thickness of the contact surface disk 350. The depth of the grooves 352 extends, as shown especially by the cross section in FIG. 10, only to roughly half the thickness of the contact surface disk 350. In particular, in the region of the contact surface disk 350 which faces away from the supporting body, there remains a connecting ring 354 which interconnects the individual contact surface segments 312a, 312b to one another. In the region of this connecting ring 354 there are handling or tool action surfaces 356 by means of which the contact surface disk 350 can be supplied mechanically to the respective supporting body in an automatic manner. The tool action surfaces 356 can be uniformly distributed in the peripheral direction, especially in the region of the contact surface segments 312a, 312b.

On the side facing the supporting body, the contact surface disk 350 forms projections 358 which can be matched with respect to their number and/or arrangement to the arrangement of the contact surface segments 312a, 312b. In particular these projections 358 can be matched in their shape and arrangement to the first widening 224 which is provided on the supporting body 202, especially can engage them positively. Simplified positioning of the contact surface disk 350 on the supporting body 302 is thus ensured.

After connecting the contact surface disk 350 to the connection segments and the supporting body 202, the contact surface disk 350 on its exposed flat surface can be turned to the height which is indicated in FIG. 10 by the dot-dash line 360. In this way turning into the region of the grooves 353 takes place so that the contact surface segments 312a, 312b are separated thereby. Therefore it is not longer necessary to make parting cuts.

FIG. 11 shows a second embodiment of a face commutator 401 in a side view, in the not yet assembled state. The supporting body 402 is shown in part in a section in the top half of the figure and in a front view in the bottom half of the figure. In the bottom half of the figure the supporting body 402 is moreover shown with the inserted connection segments 408.

One particularity compared to the previous embodiments consists in that the connection segment 408, especially its head section 408a, preferably integrally forms a collar 408e which forms at least in sections the outer ring 242 which is formed in the embodiment of FIG. 8 from the supporting body 202. In this way radially outside protection for the contact surface segments 412 and/or a contact surface for positioning and alignment of the contact surface segments 412 is formed. Moreover in this way the connection segment 408 can be additionally fixed when the coil winding is being welded on, especially in the radial direction.

Another particularity consists in that the connection segment 408 can be inserted from the side of the supporting body 402 facing the contact surface segments 412. The connection segments 408 are inserted until they strike the pertinent stop surfaces 462 of the supporting body 402 which preferably include a right angle with the longitudinal axis 404. The contact surface segments 412 on their surface 464 facing the connection segments 408 have a coating, for example of tin, copper, or brass, by which a reliable mechanical and electrical connection to the connection segments 408 is ensured.

FIG. 12 shows a top view of the embodiment of FIG. 11. The collar 408e in a top view is arc-shaped relative to the longitudinal axis 404 with an angle of arc of roughly half the angle of arc of a contact surface segment 412; in this embodiment the angle of arc of the collar 408e is approximately 20°.

FIG. 13 shows the face commutator 401 of FIG. 11 in the assembled state in a side view. On the end side of the supporting body 402 facing the contact surface segments 412 there is a recess 466 which is round in this embodiment (FIG. 11) and which forms a deposition space for the connection means for connecting the connection segment 408 to the pertinent contact surface segment 412. In the illustrated mounted state the collar 408e axially has a projection over the exposed flat surface of the contact surface segment 412. By subsequent material removal, especially by turning flat, the connection segments 408, the contact surface segments 412 and the supporting body 402 are leveled to form the contact surface 414 of the face commutator 401.

In one special alternative embodiment the collar 408e conversely does not have an axial projection over the exposed flat surface of the contact surface segment 412, but is set back relative to the flat surface or even relative to the contact surface 414, especially set back by one or more tenths of a millimeter relative to the contact surface 414. In this way, when the contact surface segments 412 are leveled, material of the collar 408e need not be removed, by which the process for example of flat turning is simplified. Typically the contact surface segments 412 in a disk combination have a thickness of approximately 2.5 mm which is reduced by flat turning to approximately 2 mm. The axial length of the collar 408e is typically between 1.5 and 1.8 mm.

In this alternative embodiment as well, the supporting body 402 can have ring segments 444a which form the inner ring and which axially have a projection distance over the exposed flat surface of the contact surface segments 412. In particular, these ring segments on their facing end can have a bevel (see also FIG. 15) by which insertion of the contact surface segments 412 is simplified. In particular when the contact surface segments 412 are inserted in a disk combination, the axial projection of the ring segments 44a reliably prevents tilting of the disk on the collar 408e and thus the danger of damage to the disk.

FIG. 14 shows the pertinent top view of the face commutator 401 of FIG. 13. The collar 408e radially outside forms the support ring for the contact surface segments 412, conversely the supporting body 402 radially inside forms a support by the inside ring 444 which is made in one piece.

FIG. 15 shows another embodiment of a supporting body 502. In contrast to the embodiment of FIG. 8, the openings 518 are adapted for holding the connection segments, their base section having roughly the shape of a kite, the radially inside tip of the kite being flattened and the radially outside tip of the kite undergoing transition into the opening for the connecting section. The angle enclosed by the facing surfaces of the radially outer region of the base section and of the radially inner region of the head section of the connection segments (compare FIG. 2) is between 30° and 60°, especially approximately 50°.

The first widening 524 is matched to the cross sectional shape of the base section of the connection segments and is especially pentagonal in the illustrated embodiment. The overlapping of the first widening 524 with reference to the opening 518 in the peripheral direction is comparatively small or even negligible in the region of the radially running boundary lines of the cross sectional shape of the opening 518. There is conversely a projection which anchors the connection segment in the supporting body 502 especially radially inside and radially outside to the other boundary lines of the cross sectional shape of the opening 518.

The ring segments 544a which form the inner ring on their face end have a bevel 544b which is pointed radially to the outside and which simplifies insertion of the contact surface segments (not shown in FIG. 15). Accordingly the ring segments 542a which form the outer ring can also have a bevel which is pointed radially to the inside.

1. Face commutator (101) having a supporting body (102) of electrically insulating material, a plurality of connection segments (108) of an electrically conductive material for connection of at least one end of a coil winding at a time, and a plurality of contact surface segments (112) which form the contact surface (14) of the face commutator (101), the contact surface segments (112) being connected mechanically tightly and by electrical conductivity to the connection segments (108), and the supporting body (102) and/or the connection segments (108) being made in one piece, and the supporting body (102) being prefabricated and having openings (118) into which the connection segments (108) are inserted, characterized in that the supporting body (102) in the region of the openings (118) with reference to the inserted connection segments (108) has at least in sections an overdimension, that the connection segments (108) are fixed as a result of the clamping action of the supporting body (102), and wherein the clamping action is caused by an overdimension of the supporting body (102) at least in sections with respect to the connection segment (108).

2. The face commutator (101) according to claim 1, wherein the connection segments (108) have a head section (108a) and a base section (108c) which are connected to one another via a connection section (108b), and wherein the connection section (108b) as a result of an overdimension of the supporting body (102) at least in sections is elastically deformed in the region of the opening (118) and thus the connection segments (108) are fixed on the supporting body (102) by clamping.

3. The face commutator (101) according to claim 1, wherein the part of the supporting body (102) located between the head section (108a) and the base section (108c) is compressively stressed by the elastic deformation of the connection segment (108).

4. The face commutator (101) according to claim 1, wherein the contact surface segments (112) have a projection relative to the connection segments (108) in the radial direction and/or peripheral direction, relative to the axis of rotation of the face commutator (101).

5. The face commutator (101) according to claim 4, wherein the contact surface segments (112) in the region of the projection at least in sections abut the supporting body (102).

6. The face commutator (101) according to claim 1, wherein the openings (118) in the supporting body (102) run with at least one directional component parallel to a longitudinal axis (104) of the supporting body (102), especially wherein the openings (118) extend parallel to the longitudinal axis (104) of the supporting body (102).

7. The face commutator (101) according to claim 1, wherein the openings (118) in the supporting body (102) in the region of the end of the connection segments (108) which faces the contact surface segments (112) have a widening (124, 128).

8. The face commutator (101) according to claim 7, wherein the connection segments (108) in the inserted state project with their end facing the contact surface segments (112) into the region of the widening (124, 128).

9. The face commutator (101) according to claim 7, wherein the widening (124, 128) of the openings (118) forms a receiving space for a connection means for connecting the connection segments (108) to the contact surface segments (112).

10. The face commutator (101) according to claim 1, wherein the connection segments (108) are anchored on the supporting body (102) by the mechanically tight connection to the contact surface segments (112).

11. The face commutator (101) according to claim 1, wherein the connection segments (108) have a coating at least in the region of the connection to the contact surface segments (112).

12. Process for producing a face commutator (101) with the following steps:
producing a supporting body (102) of an electrically insulating material, the supporting body (102) having openings (118) for accommodating the connection segments (108) of an electrically conductive material for connection of at least one end of the respective coil winding, the supporting body (102) in the region of the openings (118) with respect to the inserted connection segments (108) having at least in sections an overdimension,
insertion of the connection segments (108) into the openings (118) of the supporting body (102), the connection segments (108) being fixed as a result of the clamping action of the supporting body (102), and the clamping action being caused by an overdimension of the supporting body (102) at least in sections with respect to the connection segment (108),
fixing of the contact surface segments (112) which form the contact surface of the face commutator (101) on the face commutator (101) by mechanically strong and electrically conductive connection of the contact surface segments (112), individually or in combination, with the connection segments (108).

13. The process according to claim 12, wherein the connection segments (108) upon insertion into the supporting body (102) in the region of their end facing the contact surface segments (112) undergo a widening in the radial direction and/or peripheral direction, with respect to the axis of rotation of the face commutator (101).
